(19) United States
(12) Patent Application Publication
(10) Pub. No.: US 2022/0019790 A1
(43) Pub. Date: Jan. 20, 2022

(54) IMAGE PROCESSING APPARATUS, IMAGE PROCESSING SYSTEM, IMAGE PROCESSING METHOD, AND PROGRAM

(71) Applicant: Sony Interactive Entertainment Inc., Tokyo (JP)

(72) Inventors: Kumar Ravi, Kanagawa (JP); Takashi Hatakeda, Tokyo (JP)

(73) Assignee: Sony Interactive Entertainment Inc., Tokyo (JP)

(21) Appl. No.: 17/294,851

(22) PCT Filed: Nov. 29, 2019
(86) PCT No.: PCT/JP2019/046822

§ 371 Date: May 18, 2021

(30) Foreign Application Priority Data
Dec. 4, 2018 (JP) 2018-227190

(51) Int. Cl. G06K 9/00; G06T 7/20; G09G 5/36

(52) U.S. Cl. CPC G06K 9/00604; G09G 5/36; G06T 7/20

(57) ABSTRACT

An image processing apparatus acquires eye information regarding a state of eyes of a viewer who views a moving image, determines a drawing condition of the moving image according to the acquired eye information, and draws the moving image in accordance with the determined drawing condition.

### TECHNICAL FIELD

The present invention relates to an image processing apparatus, an image processing system, an image processing method, and a program by which a moving image is drawn.

### BACKGROUND ART

In recent years, in an image processing system in which a moving image is drawn and presented to a viewer, a demand to draw a moving image with an increasingly higher resolution and at an increasingly higher frame rate has been and is increasing in order to implement virtual reality.

### SUMMARY

### Technical Problem

If it is tried to draw and display a moving image of a high resolution and a high frame rate, then a requested performance for a processing load to a processor that performs a drawing process and so forth becomes higher.

The present invention has been made in view of such an actual situation as described above, and it is an object of the present invention to provide an image processing apparatus, an image processing system, an image processing method, and a program by which the load by a drawing process can be reduced while an influence on the quality of a moving image to be viewed by a viewer is suppressed.

### Solution to Problem

An image processing apparatus according to the present invention includes an eye information acquisition section configured to acquire eye information regarding a state of eyes of a viewer who views a moving image, a drawing condition determination section configured to determine a drawing condition of the moving image according to the acquired eye information, and a moving image drawing section configured to draw the moving image in accordance with the determined drawing condition.

An information processing system according to the present invention includes a sensor that detects a state of eyes of a viewer who views a moving image, an eye information acquisition section configured to acquire eye information regarding a state of the eyes of the viewer by using a detection result of the sensor, a drawing condition determination section configured to determine a drawing condition of the moving image according to the acquired eye information, and a moving image drawing section configured to draw the moving image in accordance with the determined drawing condition.

An image processing method according to the present invention includes a step of acquiring eye information regarding a state of eyes of a viewer who views a moving image, a step of determining a drawing condition of the moving image according to the acquired eye information, and a step of drawing the moving image in accordance with the determined drawing condition.

A program according to the present invention is a program for causing a computer to execute a step of acquiring eye information regarding a state of eyes of a viewer who views a moving image, a step of determining a drawing condition of the moving image according to the acquired eye information, and a step of drawing the moving image in accordance with the determined drawing condition. This program may be stored in and provided as a computer-readable non-transitory information processing medium.

### BRIEF DESCRIPTION OF DRAWINGS

FIG. 1 is an overall schematic view of an image processing system according to an embodiment of the present invention.

FIG. 2 is a view depicting an example of a display apparatus.

FIG. 3 is a functional block diagram depicting functions of an image processing apparatus according to the embodiment of the present invention.

FIG. 4 is a view depicting an example of a detection result of a movement of an eye along a vertical direction.

FIG. 5 is a view depicting an example of drawing time of a frame image.

FIG. 6 is a view depicting an example of a detection result of a movement of an eye in the vertical direction in which an abnormal pattern appears.

FIG. 7 is a view depicting an example of a detection result indicative of a displacement between line-of-sight directions of left and right eyes.

FIG. 8 is a view depicting an example of a flow of processing executed by a drawing condition determination section.

### DESCRIPTION OF EMBODIMENT

In the following, an embodiment of the present invention is described in detail with reference to the drawings.

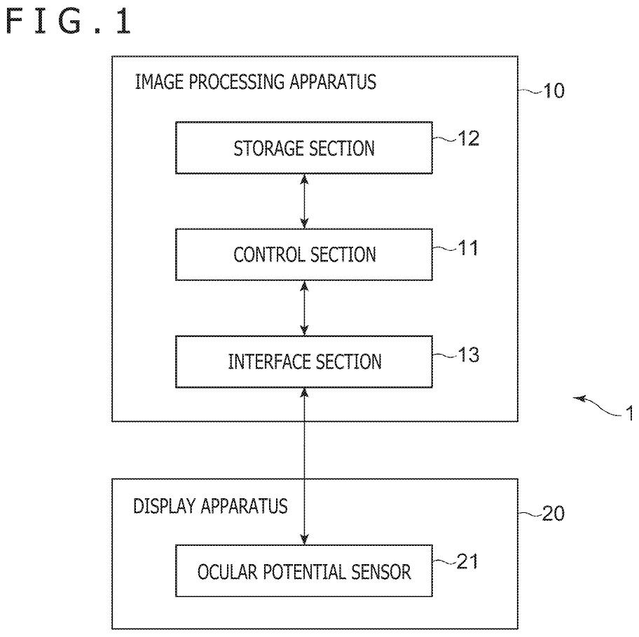

FIG. 1 is an overall schematic view of an image processing system 1 according to an embodiment of the present invention. As depicted in FIG. 1, the image processing system 1 is configured including an image processing apparatus 10 and a display apparatus 20.

The image processing apparatus 10 is an information processing apparatus such as a personal computer or a home-use game machine and is configured including a control section 11, a storage section 12, and an interface section 13. The control section 11 is configured including at least one processor and executes a program stored in the storage section 12 to execute various information processes. A particular example of the processes executed by the control section 11 in the present embodiment is hereinafter described. The storage section 12 includes at least one memory device such as a RAM (Random Access Memory) and stores programs to be executed by the control section 11 and data to be processed by the programs.

The interface section 13 is an interface for the data communication with the display apparatus 20. The image processing apparatus 10 is connected to the display apparatus 20 by wired or wireless connection through the interface section 13. In particular, in order to transmit data of a moving image drawn by the image processing apparatus 10 to the display apparatus 20, the interface section 13 includes a multimedia interface such as HDMI (registered trademark) (High-Definition Multimedia Interface). Further, in order to receive a detection signal detected by an ocular potential sensor 21 hereinafter described, the interface section 13 includes a data communication interface such as a USB (Universal Serial Bus) interface.

The display apparatus 20 is a device for displaying a moving image to be presented to a viewer. In the present embodiment, the display apparatus 20 is a display apparatus of the head-mounted type that is mounted on the head of and used by the viewer. Ocular potential sensors 21 are arranged on a face of the display apparatus 20 opposing to the viewer.

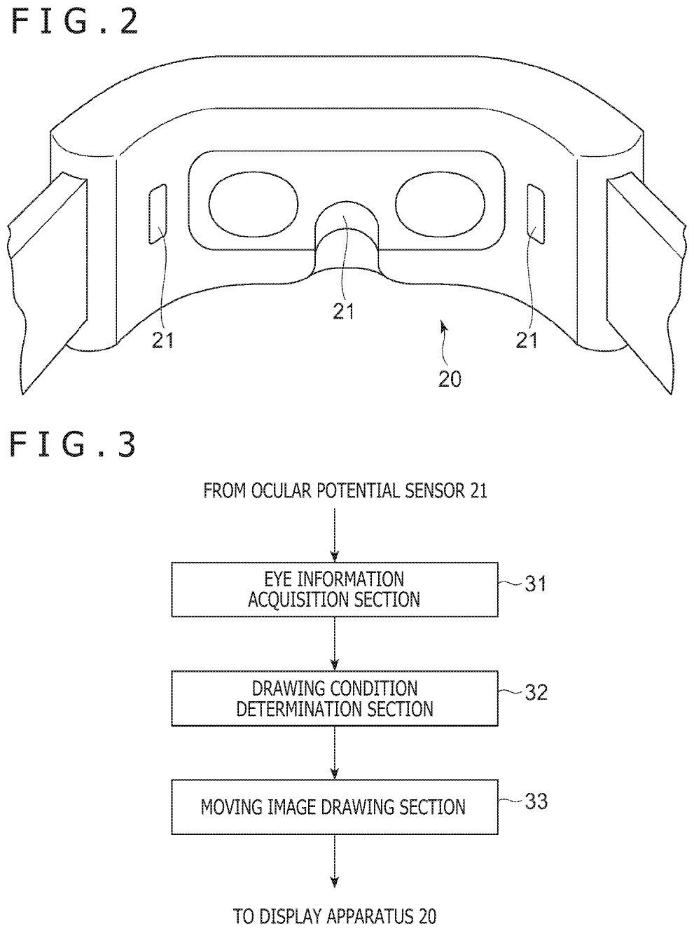

FIG. 2 is a view depicting an example of a state when the display apparatus 20 is viewed from a side thereof opposing to the viewer. The ocular potential sensors 21 are sensors for measuring a potential difference occurring around eyes of a person called ocular potential. By analyzing a detection result of the sensors, a state or a movement of the eyes such as a movement of the line-of-sight or a blink of the viewer can be specified. The ocular potential sensors 21 are arranged for contact with the skin around the eyes of the viewer such as, for example, in the proximity of the nose ridge of the viewer, in the proximity of the temples on the further outer sides of the left and right eyes. A detection result of the ocular potential sensor 21 is transmitted on the real time basis to the image processing apparatus 10.

In the following, functions implemented by the image processing apparatus 10 in the present embodiment are described with reference to FIG. 3. As depicted in FIG. 3, the image processing apparatus 10 is functionally configured including an eye information acquisition section 31, a drawing condition determination section 32, and a moving image drawing section 33. The functions are implemented by the control section 11 executing a program stored in the storage section 12. This program may be provided to the image processing apparatus 10 through a communication network such as the Internet or may be stored in and provided as a computer-readable information recording medium such as an optical disk.

While the display apparatus 20 displays a moving image, the eye information acquisition section 31 acquires information regarding a state of eyes of a viewer who is viewing the moving image. Especially in the present embodiment, the eye information acquisition section 31 acquires information regarding a timing of a blink of the viewer (hereinafter referred to as blink information) on the real time basis and notifies the drawing condition determination section 32 of the blink information. The eye information acquisition section 31 can acquire the blink information by analyzing an output of the ocular potential sensor 21.

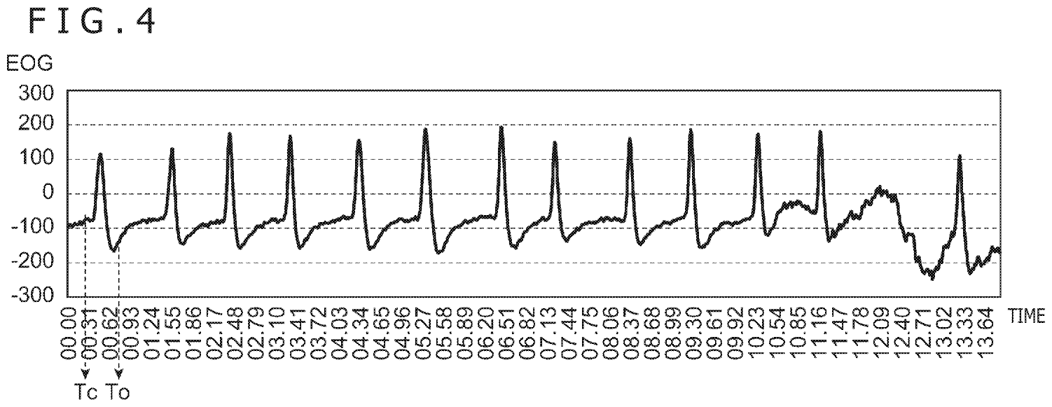

FIG. 4 depicts an example of an ocular potential diagram (EOC: electrooculogram) obtained from a detection result of the ocular potential sensor 21. In this graph, an EOG regarding the movement of the eyes along a vertical direction (upward and downward direction of the face of the viewer) is depicted. It is to be noted that the value of this EOG may be a value obtained by applying a predetermined filtering process of a bypass filter or the like to the detection result of the ocular potential sensor 21. Further, here, a waveform obtained by averaging detection results obtained in regard to each of the left and right eyes of the viewer is depicted.

As depicted in this figure, by unconscious blinks performed by the viewer, the ocular potential diagram in the vertical direction indicates a periodical waveform. In this waveform, a timing at which a rising edge of a peak starts (Tc in FIG. 4) indicates a timing at which the viewer begins to close the eyes by blinking. On the other hand, a timing at which the value begins to increase after a falling edge of the peak ends (To in FIG. 4) indicates a timing at which the viewer begins to open the eyes. By analyzing such a waveform as just described, the timing at which the viewer begins to close the eyes by blinking and the timing at which the viewer begins to open the eyes again can individually be specified. Therefore, the eye information acquisition section 31 monitors an absolute value of the value of the EOG and/or a variation amount or the like of the value of the EOG per unit period of time and, if it specifies the timing at which it begins to close the eyes and the timing at which it begins to open the eyes, then the eye information acquisition section 31 immediately notifies the drawing condition determination section 32 of this as blink information.

The drawing condition determination section 32 uses the blink information acquired by the eye information acquisition section 31 to determine a drawing condition for a moving image being displayed on the display apparatus 20. Especially, the drawing condition determination section 32 issues an instruction to the moving image drawing section 33 to draw a frame image configuring a moving image after every predetermined period of time. The moving image drawing section 33 hereinafter described draws a new frame image to be displayed subsequently every time after it accept a drawing instruction from the drawing condition determination section 32.

Further, in the present embodiment, the drawing condition determination section 32 suppresses drawing of a moving image while the viewer unconsciously performs blinking and closes the eyes. In particular, if a notification that the viewer has begun to close the eyes by blinking is received from the eye information acquisition section 31, then the drawing condition determination section 32 suspends periodical drawing instruction of a frame image. Further, if a notification that the viewer has begun to open the eyes is received from the eye information acquisition section 31, then the drawing condition determination section 32 resumes drawing instruction of a frame image. According to such control as just described, during a time zone during which it is supposed that the viewer closes the eyes by blinking, update of a frame image configuring the moving image is suspended.

The moving image drawing section 33 performs drawing of a moving image in accordance with a drawing condition determined by the drawing condition determination section 32. It is to be noted that at least part of functions of the moving image drawing section 33 may be implemented by a processor different from a processor that implements the functions of the drawing condition determination section 32 like, for example, a GPU (Graphics Processing Unit). In particular, every time the moving image drawing section 33 accepts a drawing instruction from the drawing condition determination section 32, it draws a new frame image configuring the moving image and outputs the new frame image to the display apparatus 20. On the other hand, while the drawing condition determination section 32 suspends update instruction of a frame image, the moving image drawing section 33 does not update a frame image and continues to display a frame image drawn latest in the past.

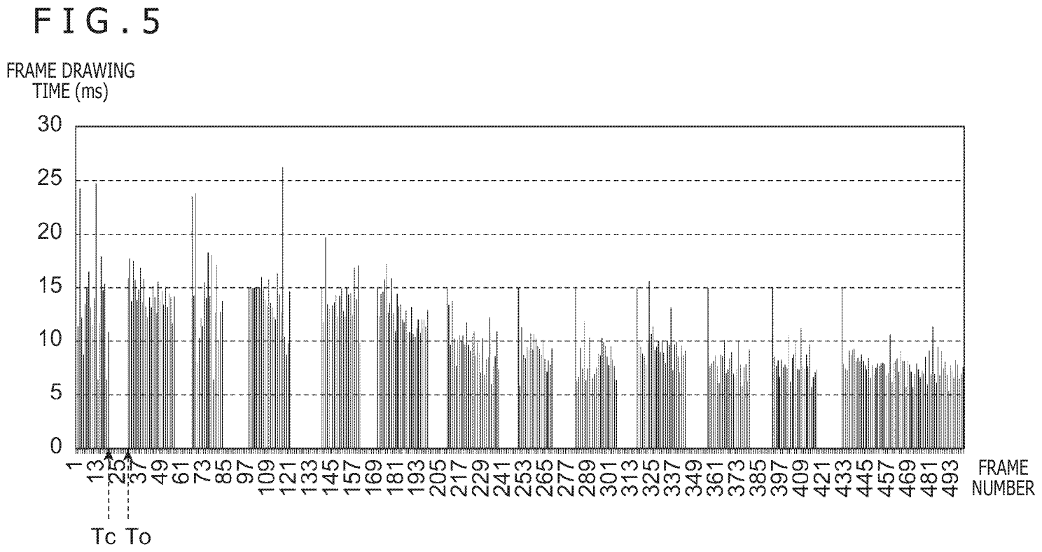

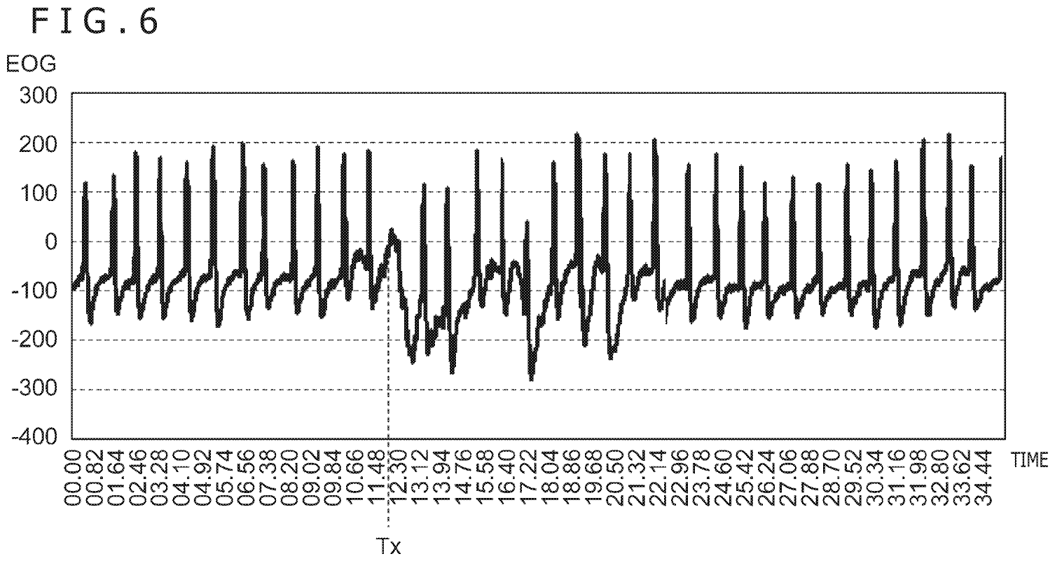

FIG. 5 is a graph depicting drawing time of a frame image and indicates a state of drawing control of a frame image within a time zone within which the ocular potential diagram of FIG. 4 is acquired. As indicated by this figure, within a time zone from a timing at which the viewer begins to close the eyes to another timing at which the viewer begins to open the eyes, drawing of an image is suspended by control of the drawing condition determination section 32. Consequently, the processing load to and the power consumption and so forth of the processor by drawing of a frame image can be reduced. Further, since the drawing frequency of a frame image decreases as a whole, the average of drawing times of frame images including processing wait time (period of time after a drawing instruction is received until drawing of a frame image is completed) can be reduced.

According to such control as just described, in comparison with an alternative case in which update of a frame image is continued always after every determined interval of time, the update frequency of a frame image (frame rate) can be reduced as a whole and the processing load by a drawing process can be reduced. On the other hand, since suspension of update of a frame image is performed at a timing at which the viewer closes the eyes, the possibility that reduction of the frame rate may be perceived by the viewer is low, and such suspension has less influence on the quality of a moving image the viewer feels.

It is to be noted that the moving image drawing section 33 may not fully suspend update of a frame image but may draw a frame image at a resolution lower than that within another time zone. In this case, while it is supposed that the viewer closes the eyes by blinking, the drawing condition determination section 32 issues an instruction to the moving image drawing section 33 to draw a frame image at a low resolution. The frame image drawn at the low resolution is enlarged and is displayed with a size same as that of the other frame images on the display apparatus 20. Also by such a process as just described, the processing load by a drawing process can be reduced while an influence on the quality of a moving image viewed by the viewer is suppressed.

Further, in the foregoing description, it is described that a drawing process of a frame image is suspended at a timing at which it is specified that the viewer begins to close the eyes and the drawing process of a frame image is resumed at a timing at which it is specified that the viewer begins to open the eyes. However, this is not restrictive, and when a period of time determined in advance from a timing at which the drawing process of a frame image starts to be suspended elapses, the drawing condition determination section 32 may resume the drawing process of a frame image irrespective of blink information at the point of time. It is supposed that the period of time of blinking that reflectively occurs irrespective of the will of the viewer is almost fixed. Therefore, by setting a period of time during which the drawing process of a frame image is suspended such that it does not exceed a period of time determined in advance, even in a case in which the timing at which the viewer begins to open the eyes cannot be specified, the drawing process of a frame image can be suspended only while it is estimated that the eyes of the viewer are closed.

The drawing condition determination section 32 may execute not only such control for suspending a drawing process of a frame image according to a timing of blinking as described above but also a process for reducing sickness of the viewer by using information regarding a state of the eyes of the viewer. This is described below.

In a case where the display apparatus 20 of the head-mounted type displays a realistic stereoscopic image, the viewer sometimes feels a motion sickness-like symptom. It has been found by the inventors of the present application that, in a case in which such a symptom as just described occurs, some abnormality occurs with an unconscious movement of the eyes such as a movement of the line of sight or blinking of the viewer at a stage earlier than a stage at which the viewer becomes aware of a symptom of sickness. Therefore, the image processing apparatus 10 according to the present embodiment detects an abnormal pattern in which the state of the eyes of the viewer changes abnormally and performs such display control as reduces the symptom of sickness according to detection of such an abnormal pattern as just described. By this, the symptom of sickness can be eliminated at an early stage.

In this example, the eye information acquisition section 31 monitors such a waveform of the EOG in the vertical direction as described above while the viewer views a moving image. Then, in a case in which a pattern (abnormal pattern) different from that arising from a blink in a normal state appears in the EOG waveform as in a case in which the occurrence frequency of blinking changes, the eye information acquisition section 31 notifies the drawing condition determination section 32 of this. In order to perform such decision as just described, the eye information acquisition section 31 may acquire a value of a parameter indicative of a pattern of blinking in a normal state (an occurrence interval of blinking, a magnitude of a peak or the like) at a timing at which it is supposed that sickness does not occur as yet like a timing immediately after the viewer starts to use the display apparatus 20. In this way, in a case where a waveform whose parameter has a value different by a predetermined threshold value or more in comparison with that of the pattern in a normal state is observed, it can be decided that an abnormal pattern appears.

FIG. 6 depicts an example in which an abnormal pattern by sickness occurs in the EOG in the vertical direction. In this figure, at a timing denoted by Tx, ordinary periodical blinking does not start and a waveform of an abnormal pattern different from the pattern till that time appears.

However, it sometimes occurs that an abnormal pattern of blinking is caused by some other factor that the viewer intentionally blinks or conversely refrains from blinking intentionally in addition to an abnormal pattern arising from sickness. Therefore, the drawing condition determination section 32 may not perform a sickness reduction process immediately when an abnormal pattern is detected but may perform a sickness reduction process in a case in which a condition determined in advance is satisfied such as a case in which a waveform of an abnormal pattern is detected repeatedly within a predetermined period. Further, the drawing condition determination section 32 may determine whether or not a sickness reduction process is to be performed by combining detection of an abnormal pattern of blinking with some other measurement result.

As a particular example, the drawing condition determination section 32 may decide whether or not a sickness symptom appears on the basis of an abnormal pattern of a movement of the line of sight along a horizontal direction (leftward and rightward direction of the face) in addition to an abnormal pattern of blinking specified by the EOG in the vertical direction. In this example, the eye information acquisition section 31 monitors also the EOG in the horizontal direction similarly to the EOG in the vertical direction and notifies, when a predetermined abnormal pattern is detected in a detection result of the monitoring, the drawing condition determination section 32 of this. The EOG in the horizontal direction mainly indicates movements of the lines of sight of the left and right eyes of the viewer.

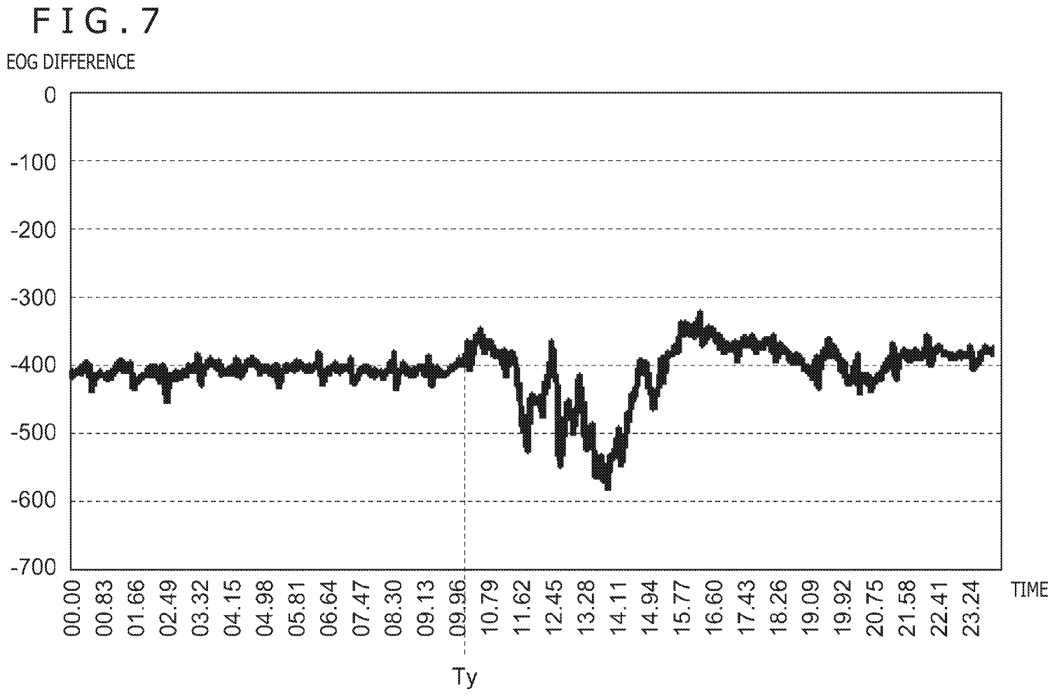

Here, the eye information acquisition section 31 calculates the difference between values of the EOG in the horizontal direction in regard to each of the left and right eyes. FIG. 7 indicates a time fluctuation of such difference of the EOG in the horizontal direction between the left and right eyes. The value of the difference indicates a displacement in movement between the left and right eyes, and in a case in which a displacement appears, this indicates that the left and right eyes move in manners different from each other. It is supposed that, when a person turns the line of sight to some direction along the horizontal direction, the directions of the lines of sight of the left and right eyes change similarly to each other. Therefore, it is presumed that, when a change occurs with the difference value, the person does not intentionally change the direction of the line of sight but a symptom arising from sickness appears as in a case in which an abnormal microsaccade occurs. Therefore, in a case in which the displacement between movements of the left and right eyes indicated by a difference value of the EOG becomes equal to or higher than a predetermined threshold value or in a like case, the eye information acquisition section 31 decides that an abnormal pattern in regard to a line-of-sight movement appears and notifies the drawing condition determination section 32 of this. Ty in FIG. 7 denotes a timing at which such an abnormal pattern appears. For example, the drawing condition determination section 32 decides that an early symptom of sickness appears in a case in which both an abnormal pattern in blinking and an abnormal pattern in line-of-sight movement appear within a predetermined period of time.

If the drawing condition determination section 32 decides that a symptom of sickness appears on the basis of an abnormal pattern of blinking and an abnormal pattern of the line-of-sight movement notified from the eye information acquisition section 31, then the drawing condition determination section 32 executes a sickness reduction process. In particular, the drawing condition determination section 32 instructs the moving image drawing section 33 to execute a drawing process of such a moving image that is less likely to cause sickness.

As a particular example of such a sickness reduction process, such processes as increasing the frame rate (raising the drawing frequency of a frame image), blurring an overall frame image by a blur effect or the like, and changing the color of a frame image so as to lower an overall contrast or the saturation are available. Further, in a case in which a moving image indicating a state in a virtual space in which various objects are arranged is drawn, the speed of movement of the viewpoint position (viewpoint camera) to be made a reference when the state in the virtual space is to be drawn may be controlled. In particular, it is possible to cause a symptom of sickness to be less likely to occur by lowering the speed of movement of the viewpoint camera.

Further, also while a sickness reduction process is being executed, the eye information acquisition section 31 continues to monitor for an abnormal pattern of blinking and the line-of-sight movement. If a state in which no abnormal pattern appears continues for a predetermined period of time, then the drawing condition determination section 32 may decide that the sickness symptom is moderated by the sickness reduction process and end the sickness reduction process.

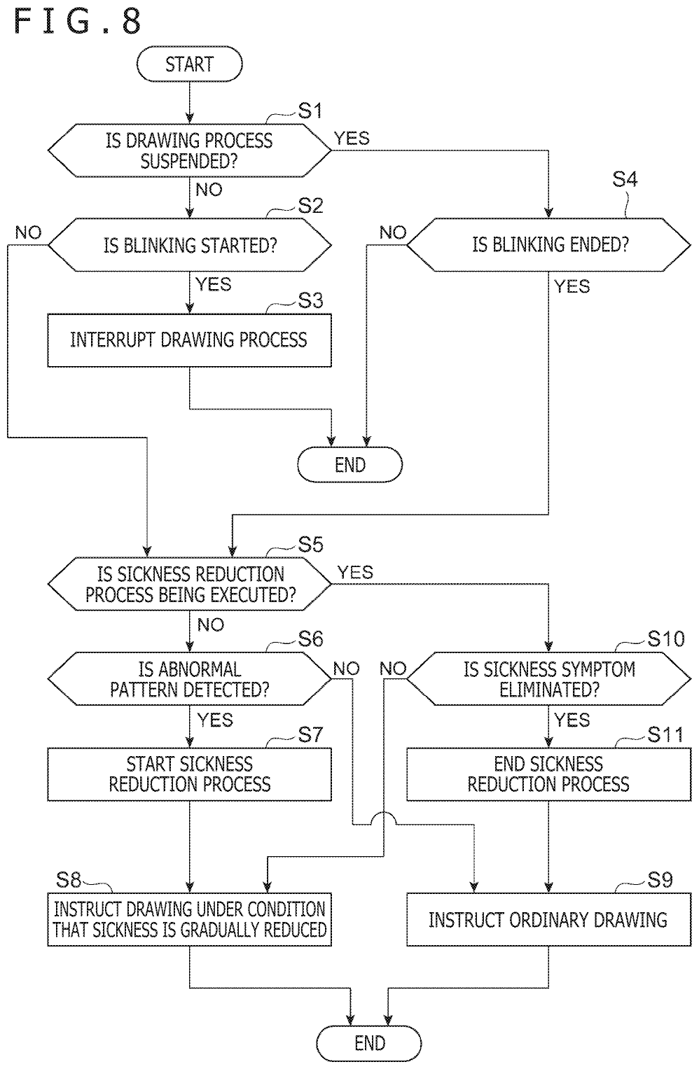

FIG. 8 depicts an example of a flow of processing executed by the drawing condition determination section 32 described above. In this figure, a flow of processing executed by the drawing condition determination section 32 every time a predetermined frame update period elapses is depicted. First, the drawing condition determination section 32 branches the processing according to whether or not it is a current state that a drawing process is suspended (S1). If the current state is not that a drawing process is suspended, then the drawing condition determination section 32 decides whether or not a notification of start of blinking (a timing at which the eyes begin to be closed) is received from the eye information acquisition section 31 (S2). If a notification of start of blinking is received, then the drawing condition determination section 32 transits to a state in which a drawing process of a frame image is suspended (S3) and ends the processing for the frame. On the other hand, if a notification of start of blinking is not received, then the drawing condition determination section 32 advances the processing to S5 hereinafter described to perform drawing instruction of the frame image.

If it is decided at S1 that it is a current state that a drawing process is suspended, then the drawing condition determination section 32 decides whether or not a notification of end of the blinking (a timing at which the eyes begin to be opened) is received from the eye information acquisition section 31 (S4). If a notification of end of the blink is received, then the drawing condition determination section 32 ends the state in which a drawing process of a frame image is suspended and advances the processing to S5, at which it resumes the drawing process. On the other hand, if a notification of end of the blink is not received, then the drawing condition determination section 32 maintains the state in which the drawing process of the frame image is suspended, the processing for the frame ends.

In a case in which the drawing process of the frame image is to be executed, the drawing condition determination section 32 subsequently branches the processing according to whether or not a sickness reduction process is being executed at present (S5). If a sickness reduction process is not being executed, then the drawing condition determination section 32 decides whether or not an abnormal pattern of blinking or a line-of-sight movement indicative of an early symptom of sick is detected (S6). If it is decided that an abnormal pattern arising from sickness occurs, the drawing condition determination section 32 transits to a state in which a sickness reduction process is executed (S7) and instructs the moving image drawing section 33 to perform drawing of a frame image in such a condition that the sickness is moderated (S8). On the other hand, if an abnormal pattern by sickness is detected, then the drawing condition determination section 32 instructs the moving image drawing section 33 to draw a frame image in an ordinary condition (S9).

If it is decided at S5 that a sickness reduction process is being executed, then the drawing condition determination section 32 decides on the basis of a notification from the eye information acquisition section 31 whether or not the symptom of sickness is eliminated (S10). If it is decided that the symptom of sickness is eliminated in that the abnormal pattern arising from sickness has not been detected for a predetermined period of time or in a like case, then the drawing condition determination section 32 ends the sickness reduction process (S11) and instructs the moving image drawing section 33 to draw a frame image in an ordinary condition (S9). On the other hand, if the symptom of sickness is not eliminated, then the drawing condition determination section 32 continues the sickness reduction process (S8).

With the image processing apparatus 10 according to the embodiment of the present invention described abnormally, it is possible to reduce the processing load by drawing by suppressing drawing of a frame image using information of blinking of a viewer. Further, by utilizing information of a state of the eyes of the viewer, it is possible to find out a symptom of sickness at an early stage and take a countermeasure for the same.

It is to be noted that the embodiment of the present invention is not restricted to that described above. For example, although, in the foregoing description, the display apparatus 20 is a display apparatus of the head-mounted type, this is not restrictive, and the display apparatus 20 may be of the stationary type. In this case, the ocular potential sensor 21 may be mounted as a device separate from and independent of the display apparatus 20 on the viewer.

Further, information regarding a movement of eyes of a viewer may be acquired not from an ocular potential sensor but from another sensor. For example, the image processing system 1 may specify the timing of blinking or a movement of the line of sight of a viewer by analyzing an image captured by a camera device directed to the position of the eyes of the viewer.

### REFERENCE SIGNS LIST

1: Image processing system
10: Image processing apparatus
11: Control section
12: Storage section
13: Interface section
20: Display apparatus
21: Ocular potential sensor
31: Eye information acquisition section
32: Drawing condition determination section
33: Moving image drawing section

1. An image processing apparatus comprising:
an eye information acquisition section configured to acquire eye information regarding a state of eyes of a viewer who views a moving image;
a drawing condition determination section configured to determine a drawing condition of the moving image according to the acquired eye information; and
a moving image drawing section configured to draw the moving image in accordance with the determined drawing condition.

2. The image processing apparatus according to claim 1, wherein
the eye information acquisition section acquires eye information regarding a timing of blinking of the viewer, and
the drawing condition determination section limits a drawing process of the moving image for a period of time that is determined according to the eye information.

3. The image processing apparatus according to claim 2, wherein
the eye information acquisition section specifies a timing at which the viewer starts the blinking, and
the drawing condition determination section starts the limitation of the drawing process of the moving image in response to the start of the blinking.

4. The image processing apparatus according to claim 3, wherein
the eye information acquisition section specifies a timing at which the viewer ends the blinking, and
the drawing condition determination section ends the limitation of the drawing process of the moving image in response to the end of the blinking.

5. The image processing apparatus according to claim 2, wherein
the eye information acquisition section acquires the eye information by using a detection result of an ocular potential sensor mounted on the viewer.

6. The image processing apparatus according to claim 1, wherein
the eye information acquisition section detects an abnormal pattern in which a state of the eyes of the viewer changes abnormally, and
the drawing condition determination section determines, when the abnormal pattern is detected, the drawing condition of the moving image such that sickness of the viewer is reduced.

7. The image processing apparatus according to claim 6, wherein the eye information acquisition section detects an abnormal pattern regarding a frequency of blinking of the viewer.

8. The image processing apparatus according to claim 6, wherein the eye information acquisition section detects an abnormal pattern regarding a line-of-sight movement of the eyes of the viewer.

9. The image processing apparatus according to claim 8, wherein the eye information acquisition section detects the abnormal pattern on a basis of a difference between line-of-sight movements of left and right eyes of the viewer.

10. An information processing system comprising:
a sensor that detects a state of eyes of a viewer who views a moving image;
an eye information acquisition section configured to acquire eye information regarding a state of the eyes of the viewer by using a detection result of the sensor;
a drawing condition determination section configured to determine a drawing condition of the moving image according to the acquired eye information; and
a moving image drawing section configured to draw the moving image in accordance with the determined drawing condition.

11. An image processing method comprising:
acquiring eye information regarding a state of eyes of a viewer who views a moving image;
determining a drawing condition of the moving image according to the acquired eye information; and
drawing the moving image in accordance with the determined drawing condition.

12. A non-transitory, computer readable storage medium containing a program, which when executed by a computer, causes the computer to perform an image processing method by carrying out actions, comprising:
acquiring eye information regarding a state of eyes of a viewer who views a moving image;
determining a drawing condition of the moving image according to the acquired eye information; and
drawing the moving image in accordance with the determined drawing condition.
